(19) United States
(12) Patent Application Publication
(10) Pub. No.: US 2008/0315831 A1
(43) Pub. Date: Dec. 25, 2008

(54) AC-TO-DC ADAPTER FOR MOBILE SYSTEM

(76) Inventors: Peter T. Li, Portland, OR (US); Don J. Nguyen, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/765,957

(22) Filed: Jun. 20, 2007

(51) Int. Cl. H02J 7/04

(52) U.S. Cl. 320/106

(57) ABSTRACT

Disclosed herein are approaches for providing an adapter that may operate efficiently to provide a DC voltage to systems requiring different voltages.

### BACKGROUND

Mobile computing systems such as a so-called laptop or notebook computers have one or more battery packs, each typically comprising two or more cells, to provide the system with power when a adapter (e.g., an AC adaptor) is not available. When the adapter is coupled to the mobile system, it provides power to the system, and if there is available additional power, it may also charge the battery pack.

Typically, adapters are configured to provide power for mobile systems whose battery packs are at specific voltages. For example, some adapters may be designed for so-called two-cell packs (e.g., 4 to 8.4 VDC), three-cell packs (e.g., 6 to 12.6 VDC), or four-cell packs (e.g., 8 to 16.8 VDC). Unfortunately, however, when an adapter is used with a system for which it is not optimally designed, it may operate inefficiently or even result in unreliable system operation. At the same time, it may be economically inefficient for providers to have to make various different adapters for the various different system voltages. Accordingly, new approaches may be desired.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a schematic diagram of an AC-TO-DC adapter in accordance with some embodiments.

FIG. 2 is a circuit diagram of a mobile system with an adapter such as the adapter of FIG. 1, in accordance with some embodiments.

FIG. 3 is a graph showing output voltage response versus applied control current for the adapters of FIGS. 1 and 2 in accordance with some embodiments.

FIG. 4 is a block diagram of a computer system in accordance with some embodiments.

### DETAILED DESCRIPTION

Disclosed herein are approaches for providing an adapter that may operate efficiently to provide a DC voltage to systems requiring different voltages.

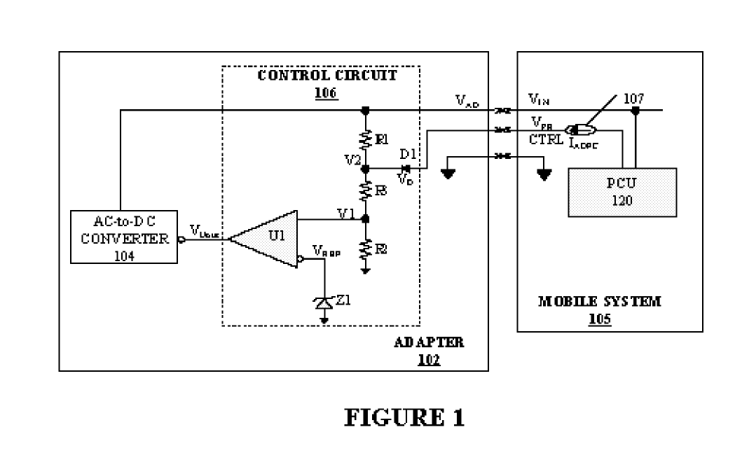

FIG. 1 shows an AC-TO-DC adapter 102 coupled to a portion of a mobile system 105 in accordance with some embodiments. The adapter 102 comprises an AC-TO-DC converter circuit 104 and a control circuit coupled to the AC-To-DC converter to control its DC output voltage (V_{AD}) in response to a control signal (CTRL) from the mobile system 105. The control circuit 106 comprises differential amplifier U1, reference voltage generator Z1, resistors R1 to R3, diode D1, all coupled together as shown. The mobile system 105 comprises a power control unit 120 and a current source 107 to generate a control signal (current I_{ADFC} in this embodiment) in order to control the voltage (V_{AD}) provided by the adapter 102.

The AC-TO-DC converter circuit 104 generates a variably-controllable output DC voltage (V_{AD}) in response to a control signal (V_{Uout}) from the amplifier U1. In the depicted embodiment, the AC-TO-DC converter's control input is complementary in that V_{AD} goes up as V_{Uout} goes down and vice versa. The AC-TO-DC converter 104 may be implemented with any suitable conventional or future design to generate a controllable DC voltage (V_{AD}) from an applied AC voltage (typically 120 or 240 VAC). It may be formed from any suitable combination of discrete components including but not limited to transformers, pulse width modulator circuits, low-pass filters, isolated optical feedback components, switches, and the like. For example, it could comprise a transformer, coupled on its primary side to the AC signal and on its secondary side, through a low-pass filter, to the DC output (V_{AD}). A PWM (Pulse Width Modulator) may be employed to regulate the amount of AC energy provided to the transformer to control the output voltage, and a feedback device, such as an opto-isolated feedback control device could be coupled between the output and PWM to regulate the output voltage and could have a control input coupled to the complementary control input (Uₒᵤₜ) to further regulate the output DC voltage in complementary response to the output from U1. In some embodiments, consistent with the adapter response illustrated in FIG. 3, the AC-TO-DC converter has a dynamic output range of at least 4 to 20 VDC.

Amplifier U1 may be implemented with any suitable difference amplifier including but not limited to a linear amplifier or even a comparator. That is, its output (Uₒᵤₜ) may provide an output with a continuous (e.g., linear) response for real-time control of V_{AD} through the AC-TO-DC converter, or alternatively, it could pulse control the AC-TO-DC converter, which could effectively integrate the Uₒᵤₜ pulse signal in its control of V_{AD}.

The reference generator (which could be implemented with any suitable device or device combination) generates a stable, accurate DC reference voltage (e.g., 1.225 V) coupled to the inverting input terminal of U1. The non-inverting input is coupled to the junction (V1) of resistors R2 and R3. When the voltage (V1) at the non-inverting terminal is higher than the reference (V_{REF}), the output of U1 controls the output of the AC-TO-DC converter to decrease and vice versa. With the AC-TO-DC converter 104 and resistors R1, R3 providing U1 with negative feedback, the voltages at the inverting (V_{REF}) and non-inverting (V1) terminals are forced to approach (if not equal) one another. Thus, the value of V_{AD} is determined by the values of R1 to R3, V_{AD} itself, and the amount of current sinked into R3 from current source 107. If there were no control current I_{ADFC}, the voltage at V1 would be determined by the adapter output voltage (V_{AD}), the values of R1, R2, and R3. So, if I_{ADFC} is zero, the output voltage V_{AD} will be fixed, as that in a conventional adapter. The control current (I_{ADFC}) is introduced to vary the adapter output voltage.

The voltage at V1 (which is forced to approach V_{REF}) is generated by the current flowing through R2. This R2 current comes from two sources: (1) the voltage dropped across R1 and R3 from the adapter output (i.e., V_{AD}-V1), and (2) the control current (I_{ADFC}). Since V1 remains substantially fixed (approaching V_{REF}), if I_{ADFC} increases, then V_{AD} goes down to keep the current in R2 substantially constant (at least from a steady-state standpoint). On the other hand, if I_{ADFC} goes down, then V_{AD} will increase. Accordingly, V_{AD} is at its maximum value when I_{ADFC} is zero and at its minimum value when I_{ADFC} is at its maximum value. With the depicted V_{AD}-I_{ADFC} response shown in FIG. 3, the resistor values are selected to provide an output adapter range from 4 to 19 VDC in response, respectively, to a control current ranging from 0 to 320 uA.

The values for R1 to R3, and operating ranges for I_{ADFC} and V_{AD} may be determined and/or otherwise selected in a variety of different ways, as would be appreciated by a person of ordinary skill. The following two equations may be used, for example, once the adapter operating voltage (V_{AD}) and control current (I_{ADFC}) ranges have been defined.

$$\begin{matrix}R 1 = \frac{{V}_{ADmax} - {V}_{ADmin}}{{I}_{ADFCmax}} & ( Eq . 1 ) \\ \frac{{V}_{REF}}{R 2} = \frac{{V}_{ADmax} - {V}_{REF}}{R 1 + R 3} & ( Eq . 2 )\end{matrix}$$

Depending on particular design concerns, different resistor value combinations may be chosen, in accordance with equations 1 and 2. In a more specific embodiment, the current control signal is used by the PCU 120 to determine the power rating of the adapter based on a received voltage V_{PR}. With reference to FIG. 1, V_{PR} will correspond to V2+V_{D} (the drop across diode D1). In some embodiments, V_{PR} may be defined as being valid when I_{ADFC} approaches zero, but is strong enough to sufficiently turn on diode D1 so that V2 can be perceived. With this approach, the values of R1, R2 and R3 can be obtained using the above equations (equations 1 and 2), along with the following equation (equation 3).

$$R 2 = \frac{{V}_{REF} \cdot R 1}{{V}_{ADmax} + {V}_{D} - {V}_{PR}} \qquad ( Eq . 3 )$$

With this approach, the adapter output voltage (V_{AD}), as well as the adapter power rating, may be controlled and ascertained, respectively, through the same signal (i.e., CTRL in the depicted embodiment). As an example, assume that the power rating voltage (V_{PR}) is to be 3.3 V (e.g., corresponding to a power rating of 90 W), the control current (I_{ADFC}) is to range from 0 to 320 μA, the drop across D1 (barely turned on) will be 0.3 V, and the adapter's output voltage (V_{AD}) is to range from 2 to 18.8 VDC (e.g., accommodating a system battery pack with one to four cells). with this example, using the above equations and rounding for standard component values, the values of R1, R2, and R3 would be 52.3 KΩ, 4.02 KΩ, and 5.76 KΩ, respectively.

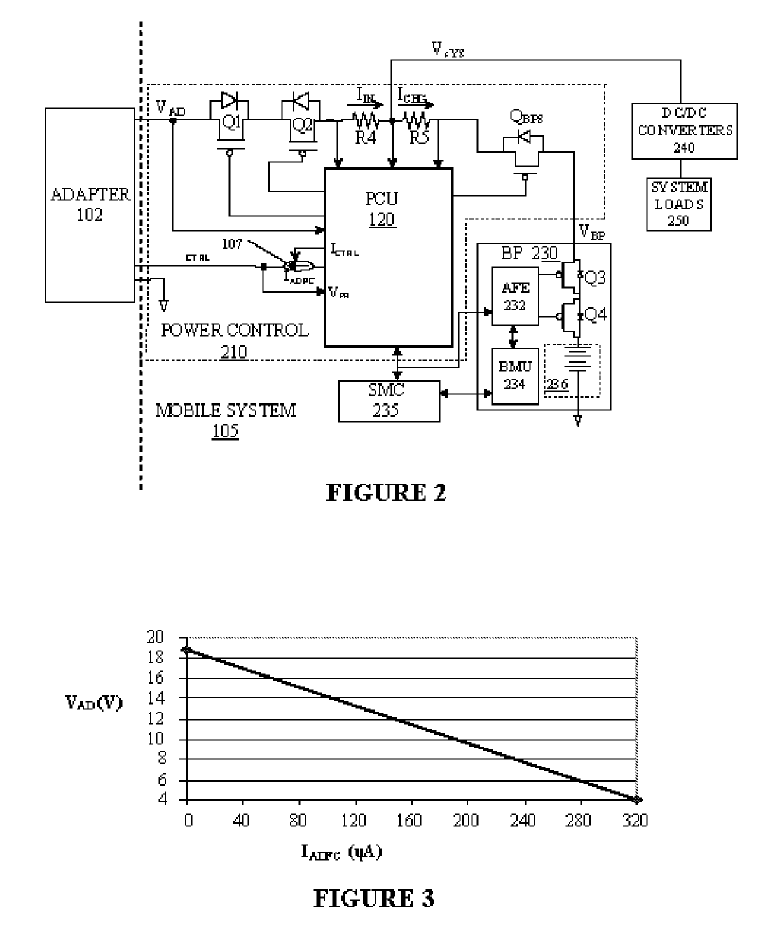

FIG. 2 shows a power control circuit 210 (with a PCU 120 such as in FIG. 1) for controlling a battery pack 230 and AC-TO-DC adapter 102 to provide power to a mobile system 105. The mobile system 105 may be any type of portable computing system such as a portable computer, personal digital assistant, cellular phone, or the like. For illustrative purposes, however, it may be treated as a portable computer such as a so-called notebook or laptop computer.

In the depicted embodiment, the mobile system 105 comprises the power control circuit 210, battery pack 230, system management controller (SMC) 235, one or more DC/DC converters 240, and loads 250 such as one or more processors, I/O components, network interface components, and the like. In some embodiments, for example, the power control circuit 210 may constitute an integrated circuit and/or discrete components housed on a motherboard of the mobile system 105. (It may be desirable to implement as many of the power control circuit functions, as is reasonably possible, on one or more chips so as to minimize discrete component count and cost.) It should be appreciated, however, that the power control circuit could alternatively be implemented, wholly or partially, in the Adapter 102, battery pack 230, and/or in other parts of the mobile system 105 or in some other module.

The battery pack 230 may be implemented with any suitable battery pack(s) configuration that can source an appropriate voltage (V_{BP}) with sufficient power for the mobile system 105. It could comprise one or more packs (e.g., selectably coupled together in parallel). Likewise, it may be conventional, as shown in the depicted embodiment, or alternatively, as with other components discussed herein, it could comprise future battery cell innovations. For example, it is believed that future cells will use different materials and/or configurations enabling them to provide lower or higher voltages with improved power and storage characteristics.

The depicted battery pack 230 comprises a plurality of series-coupled cells 236 (three in the depicted embodiment); transistor switches Q3, Q4; an analog front-end (AFE) circuit 232; and a battery management unit (BMU) circuit 234. The transistor switches Q3, Q4 are implemented with PMOS transistors, configured so that they have an associated rectification component (e.g., body diode) in the illustrated directions. They are coupled between the cells 236 and BP output terminal (V_{BP}) to control whether or not the collective voltage generated by cells 236 is provided to the BP output terminal. Each of the three cells, for example, could generate a voltage (when fully charged) of 4.2V, for example, so that V_{BP} would be 12.6 V when the cells are fully charged.

The AFE controls transistor switches Q3 and Q4 for charging, discharging, or isolating cells 236 in response to commands from either the power control circuit 210 (via the PCU 120, discussed below), the SMC 235, or the BMU 234. The BMU monitors environmental and/or operating parameters such as temperature, charge current, and discharge current in the battery pack 230 and provides information about them to the mobile system 105 through the SMC 235. It can directly control switches Q3, Q4 through the AFE 232, for example, to shut down the battery pack when an over-temperature condition occurs. It also may provide information about the battery pack (e.g., number of cells, voltage-per-cell, charging limits, and power limits) to either or both the PCU 120 and system via the SMC 235. Likewise, the PCU 120 and SMC 235 can also control switches Q3, Q4 through the AFE 232 for engaging and disengaging the battery pack in order to charge it, isolate it, or couple it to the system to provide it with power.

The power control circuit 210 generally comprises the power control unit (PCU) circuit 120, resistors: R1-R2, controllable current source 107, and transistor switches Q1, Q2, and Q_{BPS}, all coupled together as shown. The PCU 120 comprises logic and other analog and/or digital circuits (not shown) to monitor and control various power sourcing and battery charging parameters. For example, it may monitor adapter output voltage (V_{AD}), input current (I_{IN}), charge current (I_{CHG}), the power rating voltage (V_{PR}) and other received information, e.g., from the battery pack 230. It may also control the various switches and current source 107, in response to the monitored parameters and desired operating characteristics. For example, it may control the current source 107 (to control the adapter output voltage V_{AD}), the sourced input current (I_{IN}), the charge current (I_{CHG}), and possibly other operational parameters.

As with the battery pack switches Q3, Q4, the depicted transistor switches (Q1, Q2, and Q_{BPS}) are implemented with P MOS transistors, configured so that rectification (e.g., body diodes) is attained as indicated. It should be appreciated, however, that any suitable component or combination of components could be used to implement these switches. For example, pass gates, NMOS transistors, or other transistor types, with or without separate diodes, could be used).

Transistors Q1 and Q2 serve to couple/decouple the system voltage node (V_{SYS}) to/from the Adapter voltage node (V_{IN}). Q1 is used to prevent the system supply (V_{SYS}) from being exposed when the adapter 102 is removed, and Q2 is used to reject non-compliant adapters and/or for over voltage protection. Transistor switch Q_{BPS} is used to controllably couple the battery pack voltage (V_{BP}) to, or decouple it from, the system voltage (V_{SYS}), as well as to/from the adapter (V_{IN}) 102. (It should be appreciated that not all of these switches may be needed or even desired in all embodiments. On the other hand, with other embodiments, additional switches may be used or equivalent switches may be located in different places. For example, Q2 may not be used in some embodiments and additional switches may be employed in embodiments such as when additional isolation is desired or when additional battery packs are used.)

R1 and R2 serve as current sense resistors and are used by the PCU 120 to measure Adapter current (I_{IN}) and battery pack current (I_{CHG}) In this way, the PCU 120 can monitor the power being sourced by the adapter 102, as well as the power being charged into the battery pack 230. (Note that notwithstanding the indicated direction of the I_{CHG} current, the PCU 120 could also use R2 to monitor battery pack discharge current, e.g., when it is in the other direction and used to source power to the system.) Since the sense resistors R1, R2 are in power delivery paths, it may be desirable to make their resistances as small and accurate as is reasonably possible depending on design concerns and the like. Along these lines, it should be appreciated that other techniques for measuring power or current could be used. For example, current loop or current mirror circuits (e.g., with a relatively large transistor in the power delivery path) could be used. In fact, current mirror circuits could be configured out of the switch transistors (e.g., Q1, Q_{BPS}), which are in the power delivery paths anyway.

The PCU 120, among other things, functions to control the switches (Q1, Q2, and Q_{BPS}) to couple the adapter 102 to the system (via Q1, Q2) and to the battery pack 230 (via Q_{BPS}). It is coupled to the current source 107, through signal I_{CTRL}, to control I_{ADFC}, which is conveyed over the CTRL line for controlling the adapter output voltage (V_{AD}). It also receives the power rating voltage (V_{PR}) from the CTRL line, as indicated. It is designed with the adapter's output voltage versus control current response, such as the exemplary one that is shown in FIG. 3. In this way, it can control the adapter to source any suitable voltage (within range) to facilitate a mobile system, regardless of its operating voltage or the voltage/charge characteristics for its battery pack.

The PCU 120 may be implemented with any suitable combination of analog and/or digital circuits to perform various operations including those set forth herein. For example, whether or not wholly or partially integrated, it could be implemented and with combinations of particular analog and/or digital circuits, or alternatively, it could partially or wholly incorporate more generalized circuitry such as a microcontroller with available microcode. Accordingly, different operations could be performed digitally (e.g., with the use of A/D converters to digitize the incoming voltage signals, which could then be processed using digital logic), they could be performed in an analog manner, or they could be performed using both digital and analog techniques.

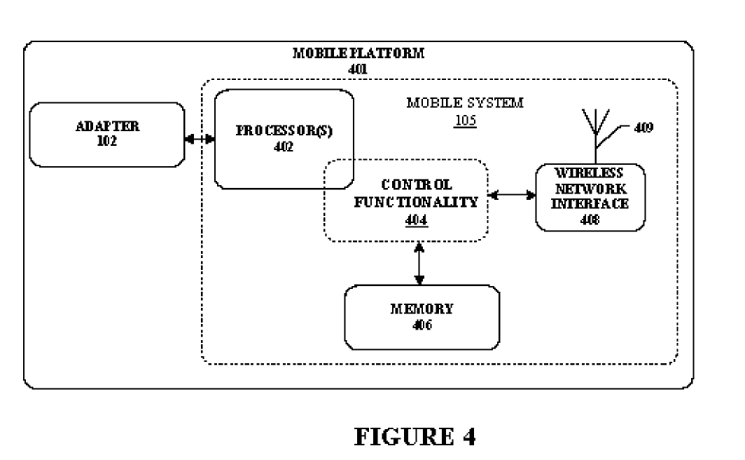

With reference to FIG. 4, one example of a portion of a platform 401 for a mobile system 105 with adapter 102 is shown. The platform 401 comprises one or more processors 402, an adapter 102, interface control functionality 404, memory 406, wireless network interface 408, and an antenna 409. The adapter 102, as discussed above, provides a DC supply to the platform components. The processor(s) 402 is coupled to the memory 406 and wireless network interface 408 through the control functionality 404. The control functionality may comprise one or more circuit blocks to perform various interface control functions (e.g., memory control, graphics control, I/O interface control, and the like. These circuits may be implemented on one or more separate chips and/or may be partially or wholly implemented within the processor(s) 402.

The memory 406 comprises one or more memory blocks to provide additional random access memory to the processor(s) 402. it may be implemented with any suitable memory including but not limited to dynamic random access memory, static random access memory, flash memory, or the like. The wireless network interface 408 is coupled to the antenna 409 to wirelessly couple the processor(s) 402 to a wireless network (not shown) such as a wireless local area network or a cellular network.

The mobile platform 401 may implement a variety of different computing devices or other appliances with computing capability. Such devices include but are not limited to laptop computers, notebook computers, personal digital assistant devices (PDAs), cellular phones, audio and/or or video media players, and the like. It could constitute one or more complete computing systems or alternatively, it could constitute one or more components useful within a computing system.

In the preceding description, numerous specific details have been set forth. However, it is understood that embodiments of the invention may be practiced without these specific details. In other instances, well-known circuits, structures and techniques may have not been shown in detail in order not to obscure an understanding of the description. With this in mind, references to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the preceding description and following claims, the following terms should be construed as follows: The terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

The term “PMOS transistor” refers to a P-type metal oxide semiconductor field effect transistor. Likewise, “NMOS transistor” refers to an N-type metal oxide semiconductor field effect transistor. It should be appreciated that whenever the terms: “MOS transistor”, “NMOS transistor”, or “PMOS transistor” are used, unless otherwise expressly indicated or dictated by the nature of their use, they are being used in an exemplary manner. They encompass the different varieties of MOS devices including devices with different VTs, material types, insulator thicknesses, gate(s) configurations, to mention just a few. Moreover, unless specifically referred to as MOS or the like, the term transistor can include other suitable transistor types, e.g., junction-field-effect transistors, bipolar-junction transistors, metal semiconductor FETs, and various types of three dimensional transistors, MOS or otherwise, known today or not yet developed.

The invention is not limited to the embodiments described, but can be practiced with modification and alteration within the spirit and scope of the appended claims. For example, it should be appreciated that the present invention is applicable for use with all types of semiconductor integrated circuit (“IC”) chips. Examples of these IC chips include but are not limited to processors, controllers, chip set components, programmable logic arrays (PLA), memory chips, network chips, and the like.

It should also be appreciated that in some of the drawings, signal conductor lines are represented with lines. Some may be thicker, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

It should be appreciated that example sizes/models/values/ranges may have been given, although the present invention is not limited to the same. As manufacturing techniques (e.g., photolithography) mature over time, it is expected that devices of smaller size could be manufactured. In addition, well known power/ground connections to IC chips and other components may or may not be shown within the FIGS, for simplicity of illustration and discussion, and so as not to obscure the invention. Further, arrangements may be shown in block diagram form in order to avoid obscuring the invention, and also in view of the fact that specifics with respect to implementation of such block diagram arrangements are highly dependent upon the platform within which the present invention is to be implemented, i.e., such specifics should be well within purview of one skilled in the art. Where specific details (e.g., circuits) are set forth in order to describe example embodiments of the invention, it should be apparent to one skilled in the art that the invention can be practiced without, or with variation of, these specific details. The description is thus to be regarded as illustrative instead of limiting.

What is claimed is:

1. An apparatus, comprising:
an AC-to-DC converter to generate a controllably variable DC supply voltage for a mobile system from a set of mobile systems having battery packs with two or more different operational voltage ranges; and
a control circuit coupled to the AC-to-DC converter to control the DC supply voltage in response to a control signal from the mobile system, wherein the control circuit can control the AC-to-DC converter to generate voltages over an adapter range that covers the two or more different battery pack voltage ranges.

2. The apparatus of claim 1, in which the control circuit comprises:
a difference amplifier coupled to a control input of the AC-to-DC converter, and
a resistor network coupled between an output of the AC-to-DC converter and a first input of said difference amplifier to provide negative feedback for said amplifier, the AC-to-DC converter output to provide the DC supply voltage.

3. The apparatus of claim 2, further comprising a reference generator coupled to a second input of the difference amplifier.

4. The apparatus of claim 2, in which the resistor network comprises two or more resistors to control the supply voltage over the adapter voltage range in response to the control signal.

5. The apparatus of claim 4, in which the control circuit comprises a diode to be coupled between the mobile system and a node in the resistor network to provide a channel for the control signal to inject a control current into the resistor network.

6. The apparatus of claim 5, in which a power rating voltage indicating a power rating for the converter is provided to the mobile system from the diode when coupled to the mobile system.

7. The apparatus of claim 1, in which the AC-to-DC converter comprises a pulse width modulator to controllably modulate the amount of AC energy provided to a transformer to control the DC supply voltage.

8. The apparatus of claim 7, in which the control circuit comprises:
a difference amplifier coupled to a control input of the AC-to-DC converter, said control input being coupled to the pulse width modulator, and a resistor network coupled between an output of the AC-to-DC converter and a first input of said difference amplifier to provide negative feedback for said amplifier, the AC-to-DC converter output to provide the DC supply voltage.

9. The apparatus of claim 8, in which the control input is a complementary control input.

10. The apparatus of claim 1, in which the converter and control circuit are configured to accommodate mobile systems with battery packs having any of one to four cells.

11. A system, comprising:
an adapter to provide a DC voltage whose level is controllable in response to a control signal; and
a mobile system having a battery pack and a power control unit to generate the control signal to control the DC voltage level to be suitable for the battery pack.

12. The system of claim 11, in which the DC supply voltage versus control signal response is the same for a plurality of mobile systems with battery packs having different operational voltage ranges.

13. The system of claim 11, in which the adapter comprises an AC-to-DC converter to generate DC supply voltage, and a control circuit coupled to the AC-to-DC converter to control the DC supply voltage in response to the control signal.

14. The apparatus of claim 13, in which the control circuit comprises a a difference amplifier coupled to a control input of the AC-to-DC converter, and a resistor network coupled between an output of the AC-to-DC converter and a first input of said difference amplifier to provide negative feedback for said amplifier, the AC-to-DC converter output to provide the DC supply voltage.

15. The apparatus of claim 14, in which the resistor network comprises two or more resistors to control the supply voltage over the adapter voltage range in response to the control signal.

16. The apparatus of claim 15, in which the control circuit comprises a diode to be coupled between the mobile system and a node in the resistor network to provide a channel for the control signal to inject a control current into the resistor network.

17. The apparatus of claim 16, in which a power rating voltage indicating a power rating for the converter is provided to the mobile system from the diode when coupled to the mobile system.

18. A system, comprising:
an adapter to provide a DC voltage whose level is controllable by a current signal; and
a mobile system having a battery pack and a power control unit to generate the current signal to control the DC voltage level based on information received from the battery pack.

19. The system of claim 18, in which the adapter comprises a resistor network comprising two or more resistors to control the supply voltage over the adapter voltage range in response to the current signal.

20. The system of claim 19, comprising a diode to be coupled between the mobile power control unit and a node in the resistor network to provide a channel for the control signal to inject a control current into the resistor network.
